(19) United States
(12) Patent Application Publication
(10) Pub. No.: US 2024/0323995 A1
(43) Pub. Date: Sep. 26, 2024

(54) SECONDARY NODE REQUESTED MEASUREMENT GAPS AT SECONDARY NODE ADDITION

(71) Applicant: Telefonaktiebolaget LM Ericsson (publ), Stockholm (SE)

(72) Inventors: Alberto Gonzalez Escudero, Linkoping (SE); Mattias Gustafsson, Hasselby (SE)

(21) Appl. No.: 18/577,849

(22) PCT Filed: Jul. 12, 2021
(86) PCT No.: PCT/EP2021/069275

§ 371 Date: Jan. 9, 2024

(51) Int. Cl. H04W 72/542; H04W 36/00

(52) U.S. Cl. CPC H04W 72/542; H04W 36/0069; H04W 36/0085

(57) ABSTRACT

A communication network can include first network node and a second network node. One of the first network node and the second network node can be a master node, MN, and the other of the one of the first network node and the second network node can be a secondary node, SN. The first network node can communicate measurement gap configuration information with the second network node. The measurement gap configuration information comprises at least one of: an indication of a set of candidate measurement gap configurations; and an indication of a selected candidate measurement gap configuration of the set of candidate measurement gap configurations selected by the SN. Responsive to communicating the measurement gap configuration information, the first network node can communicate with a communication device using a measurement gap configuration based on the measurement gap configuration information.

### TECHNICAL FIELD

The present disclosure relates generally to communications, and more particularly to communication methods and related devices and nodes supporting wireless communications.

### BACKGROUND

FIG. 1 illustrates an example of a new radio (“NR”) network (e.g., a 5th Generation (“5G”) network) including a 5G core (“5GC”) network 130, network node 120 (e.g., 5G base station (“gNB”)), multiple communication devices 110 (also referred to as user equipment (“UE”)).

FIG. 2 illustrates an example of 5GC network architecture. In this example, the 5GC network includes a unified data repository (“UDR”) 232, a network exposure function (“NEF”) 234, a network data analytics function (“NWDAF”) 236, an application function (“AF”) 238, a policy charging function (“PCF”) 242, a charging function (“CHF”) 244, an access and mobility management function (“AMF”) 246, and a session management function (“SMF”) 248 all communicatively coupled to each other. The 5GC network further includes a user plane function (“UPF”) 250 communicatively coupled to the SMF 248.

The CHF 244 can support offline and online charging functionality and exposes the Nchf interface towards the consumers (e.g., the SMF 248). The SMF 248 can support session establishment, modification, and release. In additional or alternative examples, the SMF 248 can support policy related functionalities like termination of interfaces towards PCF 242. In additional or alternative examples, the SMF 248 can support charging data collection, supporting charging interfaces, and control and coordination of charging data collection at the UPF 250. In additional or alternative examples, the SMF 248 receives policy and charging control (“PCC”) rules from the PCF 242 and configures the UPF 250 accordingly through N4 reference point. The SMF 248 controls the packet processing in the UPF 250 by establishing, modifying, or deleting PFCP Sessions and by provisioning (e.g., adding, modifying, or deleting) packet detection rules (“PDRs”), forwarding action rules (“FARs”), quality of service enforcement rule (“QERs”), and/or usage reporting rules (“URRs”) per packet forward control protocol (“PFCP”) session, whereby a PFCP session may correspond to an individual packet data unit (“PDU”) session or a standalone PFCP session not tied to any PDU session.

Each PDR includes packet detection information (“PDI”) specifying the traffic filters or signatures against which incoming packets are matched. Each PDR is associated to the following rules providing the set of instructions to apply to packets matching the PDI: one FAR, which includes instructions related to the processing of the packets, specifically forward, redirect, apply header enrichment, duplicate, drop, or buffer the packet with or without notifying the CP function about the arrival of a DL packet; zero, one, or more QERs, which include instructions related to the QoS enforcement of the traffic; and zero, one, or more URRs, which include instructions related to traffic measurement and reporting.

In some examples, the SMF 248 is able to request the UPF 250 redirect traffic (e.g., through a FAR including Redirect Information information element (“IE”). In additional or alternative examples, the SMF 248 is able to request the UPF 250 trigger header enrichment (e.g., through a FAR Header Enrichment IE).

The UPF 250 can support different functionality, for example, handling of user plane traffic, including packet inspection, packet routing and forwarding. In some examples, the UPF 250 can handle traffic usage reporting or quality of service (“QoS”) handling, charging/reporting (e.g., through FARs, QERs, URRs).

The PCF 242 can support unified policy framework to govern network behavior. The PCF 242 can also provide a policy rule to a control plane function to enforce them. The PCF 242 can also access subscription information relevant for policy decisions in the UDR 232.

### SUMMARY

According to some embodiments, a method performed by a first network node in a communications network that includes a second network node is provided. One of the first network node and the second network node is a master node, MN, and the other of the one of the first network node and the second network node is a secondary node, SN. The method includes, communicating measurement gap configuration information with the second network node. The measurement gap configuration information comprises at least one of: an indication of a set of candidate measurement gap configurations; and an indication of a selected candidate measurement gap configuration of the set of candidate measurement gap configurations selected by the SN. The method further includes, responsive to communicating the measurement gap configuration information, communicating with a communication device using a measurement gap configuration based on the measurement gap configuration information.

According to other embodiments, a first network node, a second network node, a master node, a secondary node, computer program, computer program code, and non-transitory computer-readable medium is proved to perform the method above.

Various embodiments herein, provide one or more of the following technical advantages. In some embodiments, SN requested measurement gaps at SN Addition can reduce a number of RRC reconfigurations; expedite SN configured measurements, resulting in, for example, faster setup of measurement-based carrier aggregation; and increased capacity to optimize the gap pattern used.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of a core network of a wireless communication system;

FIG. 3 is a signal flow diagram illustrating an example of a SN Addition procedure;

FIG. 4 is a signal flow diagram illustrating an example of a SN Modification procedure initiated by the MN;

FIG. 5 is a signal flow diagram illustrating an example of a SN Modification procedure initiated by the SN with MN involvement;

FIG. 6 is a block diagram illustrating an example of a NR network architecture;

FIG. 7 is a table illustrating an example of CU to DU RRC information

FIG. 8 is a table illustrating an example of DU to CU RRC information;

FIG. 9 is a table illustrating an example of gap pattern configurations;

FIG. 10 is a signal flow diagram illustrating an example of problems with a SN Addition;

FIG. 11 is a table illustrating an example of a SgNB Addition Request according to some embodiments of inventive concepts;

FIG. 12 is a table illustrating an example of a measurement gap candidate list according to some embodiments of inventive concepts;

FIG. 13 is a diagram illustrating an example of a CG-ConfigInfo message according to some embodiments of inventive concepts;

FIG. 14 is a signal flow diagram illustrating an example of a SN Addition procedure according to some embodiments of inventive concepts;

FIG. 15 is a block diagram illustrating a communication device according to some embodiments of inventive concepts;

FIG. 16 is a block diagram illustrating a radio access network RAN node (e.g., a base station eNB/gNB) according to some embodiments of inventive concepts;

FIG. 17 is a block diagram illustrating a core network CN node (e.g., an AMF node, an SMF node, etc.) according to some embodiments of inventive concepts;

FIG. 18 is a flow chart illustrating an example of operations of a first network node according to some embodiments of inventive concepts;

FIG. 19 is a block diagram of a communication system in accordance with some embodiments;

FIG. 20 is a block diagram of a user equipment in accordance with some embodiments

FIG. 21 is a block diagram of a network node in accordance with some embodiments;

FIG. 22 is a block diagram of a host computer communicating with a user equipment in accordance with some embodiments;

FIG. 23 is a block diagram of a virtualization environment in accordance with some embodiments; and

FIG. 24 is a block diagram of a host computer communicating via a base station with a user equipment over a partially wireless connection in accordance with some embodiments in accordance with some embodiments.

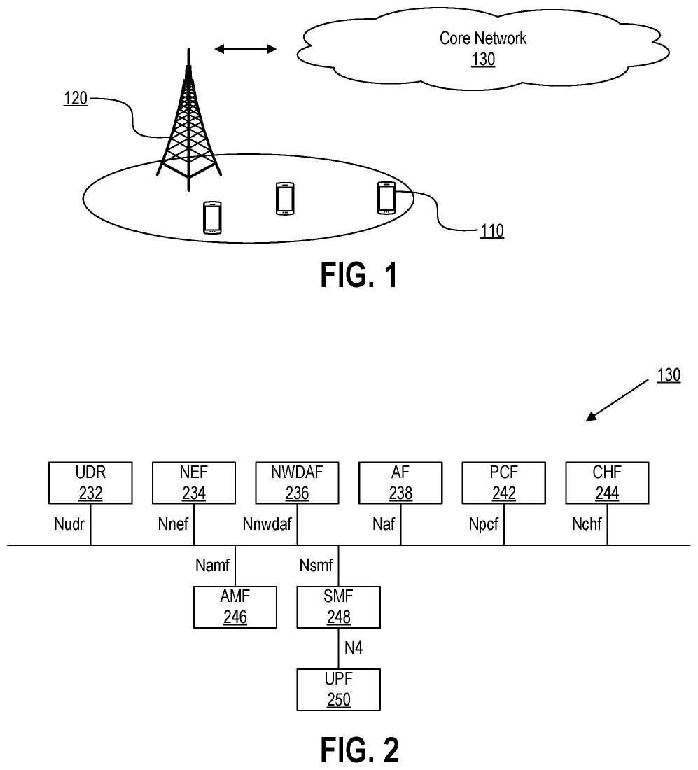

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Measurement gaps are pauses in downlink (“DL”) and uplink (“UL”) scheduling where UEs are not expected to be receive/transmit date. These gaps can be provided so that UEs can perform inter-frequency measurements, inter-RAT measurements, or intra-frequency measurements.

In dual connectivity (“DC”), when a master node (“MN”) configures gaps, there can be 3 types of gaps: (1) PerUE gaps, impacting all serving cells; (2) PerFR1 gaps, impacting LTE and NR frequency range 1 (“FR1”) (e.g., sub-6 GHZ frequency bands) serving cells; and (3) PerFR2 gaps, impacting NR frequency range 2 (“FR2”) (e.g., 24.25-52.6 GHz frequency bands) serving cells.

In a multi-radio access technology dual connectivity (“MR-DC”) network (e.g., a new radio dual connectivity (“NR-DC”) network or an evolved terrestrial radio access dual connectivity network EN-DC network), the secondary node (“SN”) can also configure gaps, but only perFR2 gaps. PerFR1 and perFR2 gaps cannot be configured together with PerUE gaps and can be only configured if the UE supports independentGapConfig capability.

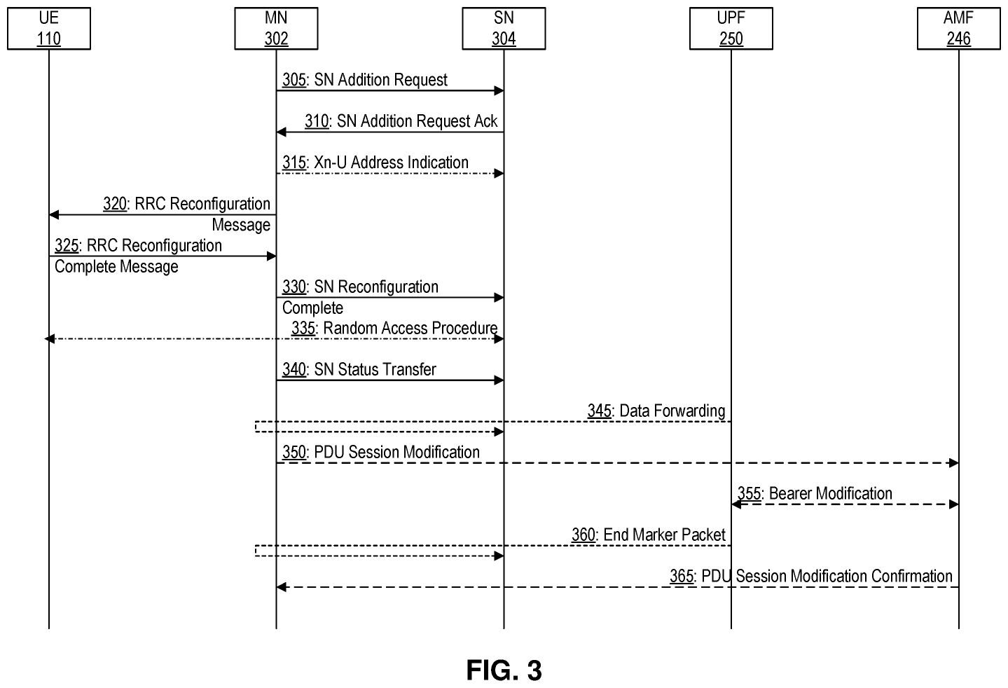

When the measurement gap is decided by the MN, the gap can be configured in one of the scenarios illustrated by FIGS. 3-5.

As illustrated in FIG. 3, when the measurement gap is decided by the MN, the gap can be configured if needed for MN measurements at a secondary gNB in DC (“SgNB”) Addition Request. The SN can be informed by including the gap in measConfigMN inside of cg-ConfigInfo.

At operation 305, MN 302 transmits a SN Addition Request to SN 304. At operation 310, SN 304 transmits a SN Addition Request Acknowledge to MN 302. At operation 315, MN 302 transmits an XN-U Address Indication to the SN 304. At operation 320, MN 302 transmits a RRC Reconfiguration Message to the UE 110. At operation 325, the UE 110 transmits a RRC Reconfiguration Complete Message to the MN 302. At operation 330, the MN 302 transmits a SN Reconfiguration Complete to the SN 304. At operation 335, the UE 110 and the SN 304 perform a Random Access Procedure. At operation 340, MN 302 transmits a SN Status Transfer to the SN 304. At operation 345, data from UPF 250 is forwarded by MN 302 to SN 304. At operation 350, MN 302 transmits a PDU Session Modification to the AMF 246. At operation 355, the UPF 250 and an AMF 246 perform bearer modification. At operation 360, an end marker packet is forwarded from the UPF 250 to the SN 304 via MN 302. At operation 365, AMF 246 transmits a PDU Session Modification Confirmation to the MN 302.

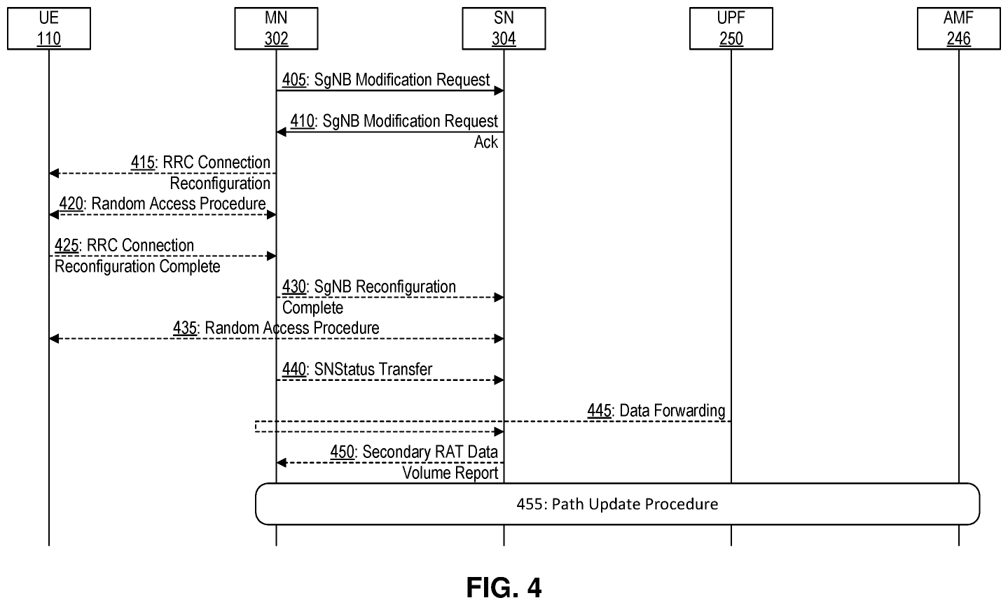

As illustrated in FIG. 4, when the measurement gap is initiated by the MN, the gap can be configured if need for MN measurements at a SgNB Modification Request. In some examples, the gap can be included in measConfigMN inside of cg-ConfigInfo.

At operation 405, the MN 302 transmits a SgNB Modification Request to the SN 304. At operation 410, SN 304 transmits a SgNB Modification Request Acknowledge to the MN 302. At operation 415, the MN 302 transmits a RRC Connection Reconfiguration to the UE 110. At operation 420, the UE 110 and the MN 302 perform a Random Access Procedure. At operation 425, the UE 110 transmits a RRC Connection Reconfiguration Complete to the MN 302. At operation 430, the MN 302 transmits a SgNB Reconfiguration Complete to the SN 304. At operation 435, the UE 110 and the SN 304 perform a Random Access Procedure. At operation 440, the MN 302 transmits a SN Status Transfer to the SN 304. At operation 445, data is forwarded from the UPF 250 to the SN 304 via the MN 302. At operation 450, the SN 304 transmits a Secondary RAT Data Volume Report to the MN 302. At operation 455, a path update procedure is performed.

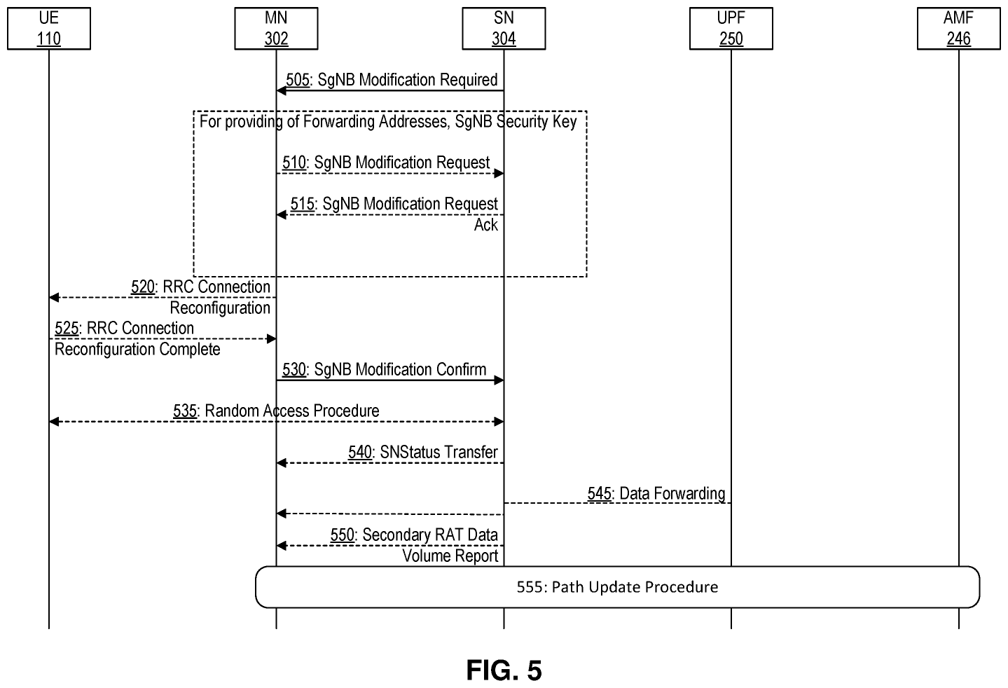

As illustrated in FIG. 5, when the measurement gap is initiated by the SN, the gap can be configured if needed for SN measurements at a SgNB Modification Required, where the SN provides a list of frequencies to measure on. The MN then decides a fitting gap pattern, and provides the answer if a SgNB Modification Request, including measConfigMN (example indicated as “For providing of Forwarding addresses, SgNB Security Key”)

At operation 505, the SN 304 transmits a SgNB Modification Required message to the MN 302. Operations 510 and 515 Provide forwarding addresses and a SgNB Security Key. At operation 510, MN 302 transmits a SgNB Modification Request to the SN 304. At operation 515, the SN 304 transmits a SgNB Modification Request Acknowledge to the MN 302. At operation 520, MN 302 transmits a RRC Connection Reconfiguration to the UE 110. At operation 525, the UE 110 transmits a RRC Connection Reconfiguration Complete to the MN 302. At operation 530, the MN 302 transmits a SgNB Modification Confirm to the SN 304. At operation 535, the UE 110 and the SN 304 perform a Random Access Procedure. At operation 540, the SN 304 transmits a SN Status Transfer to the MN 302. At operation 545, data is forwarded from the UPF 250 to the MN 302 via the SN 304. At operation 550, the SN 304 transmits the Secondary RAT Data Volume Report to the MN 302. At operation 555, a path update procedure is performed.

In additional or alternative examples, in EN-DC the gap can be configured at a SN Addition, if the UE supports independent gap configuration, and the serving cell is FR2.

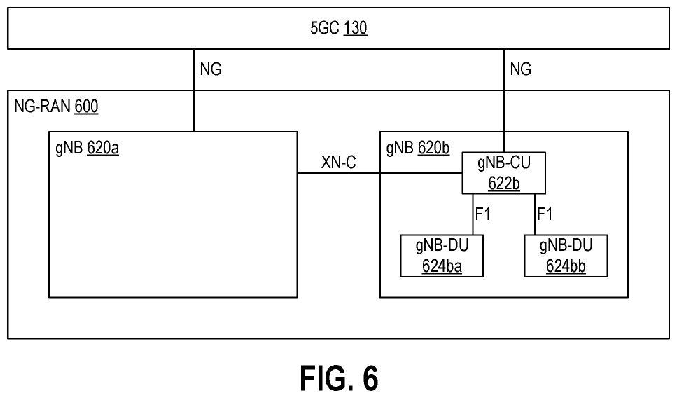

FIG. 6 illustrates an example of a NR network architecture. The NR network architecture includes a 5GC 130 coupled to a NG-RAN 600. The NG-RAN can include a pair of gNB 620a-b coupled via a Xn-C interface. One of the gNB 620b can include a gNB central unit (“gNB-CU”) 622b coupled to a pair of gNB distributed units (“gNB-DUs”) 624ba, 624bb each by a F1 interface.

The gNB-CU 622b can configure measurements and the gNB-DU 624ba, 624bb can configure a corresponding measurement gap pattern. This can be achieved by providing a list of measurements (MeasConfig information element (“IE”) element in NR radio resource control (“RRC”)) to the gNB-DU 624ba, 624bb, to which the gNB-DU 624ba, 624bb responds with a MeasGapConfig to the gNB-CU 622b.

The gNB-CU 622b includes the measGapConfig IE in the MeasConfig IE and sends it to the UE in a RRC reconfiguration.

When it is the MN configuring the measurement gap, the gap information is forwarded to the SgNB-DU inside the measConfigMN in cg-ConfigInfo IE.

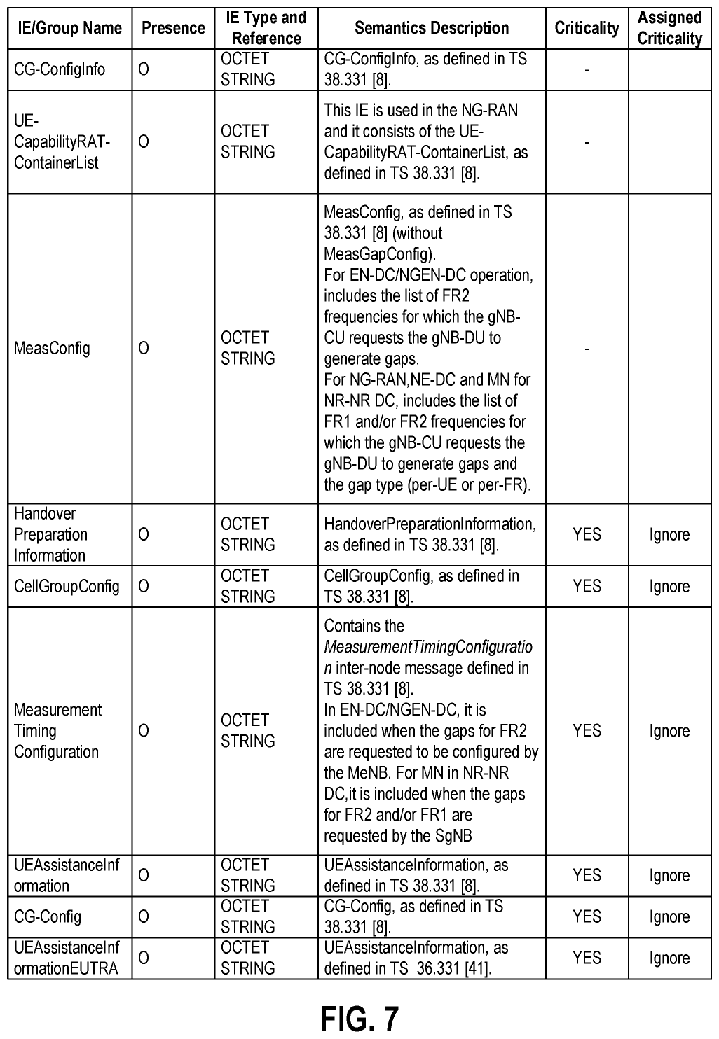

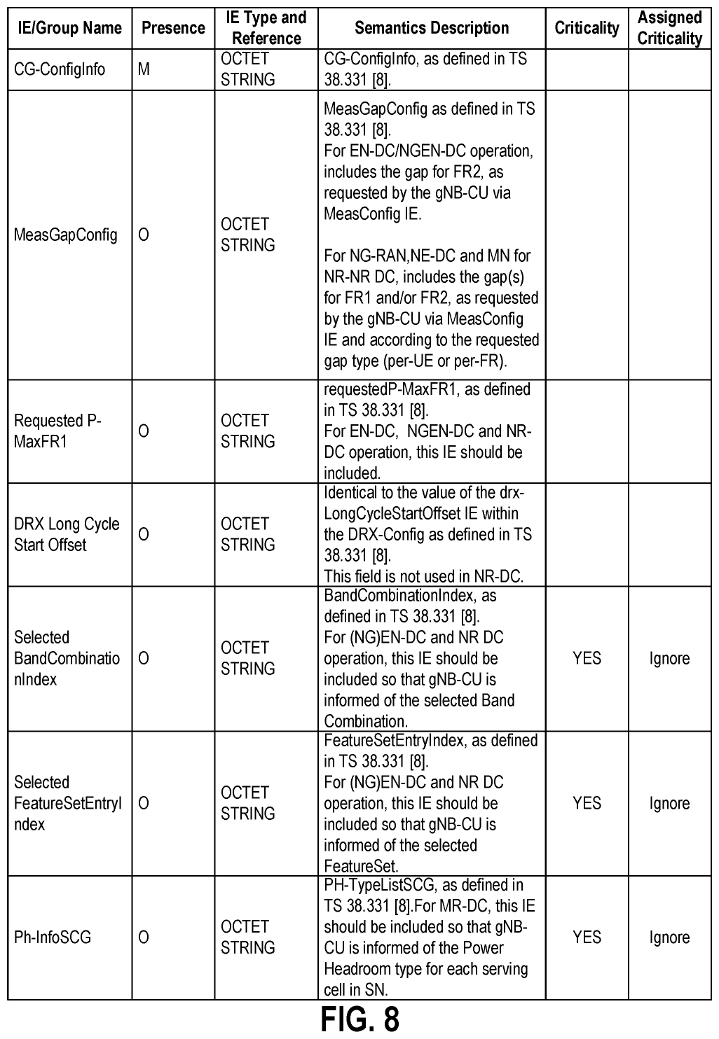

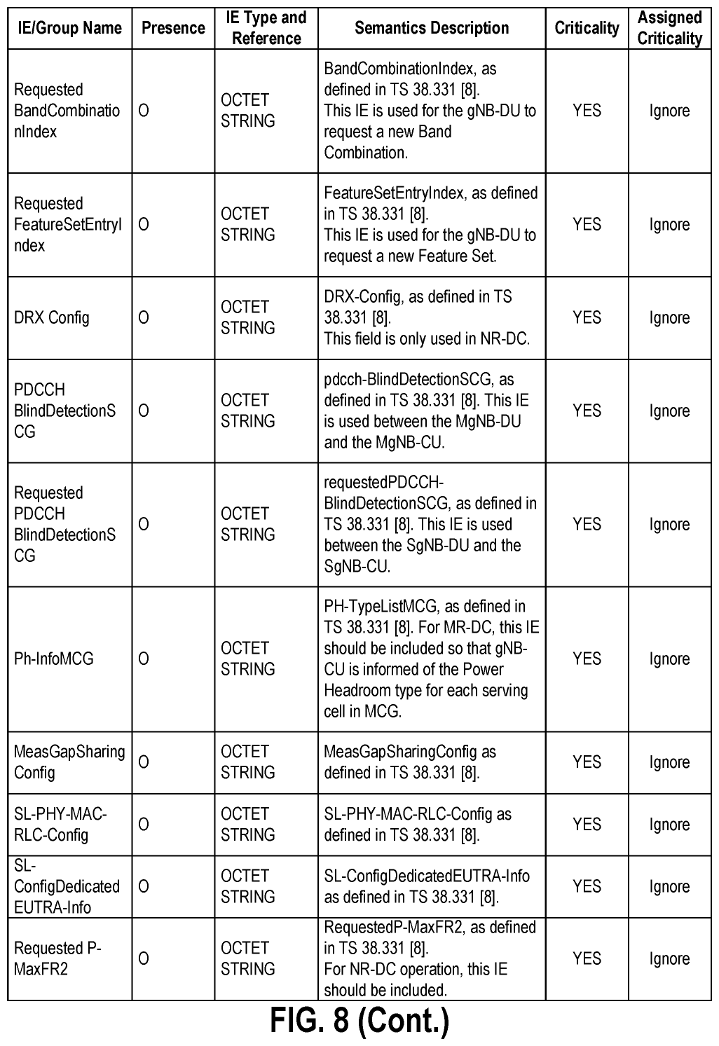

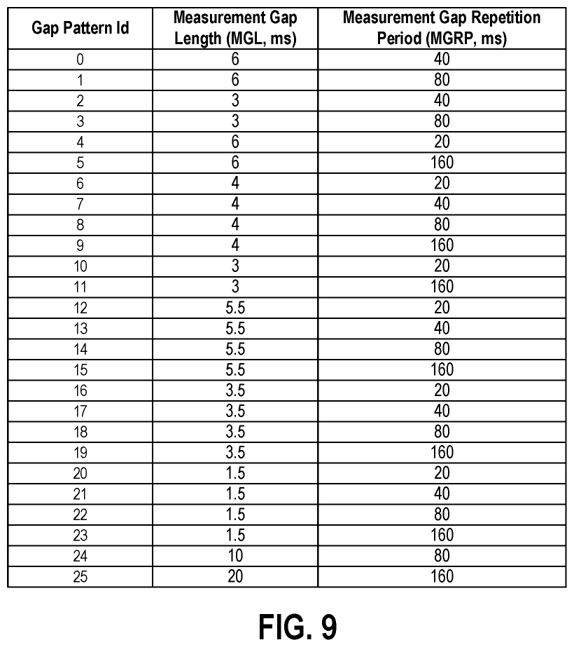

FIG. 7 is a table illustrating an example of CU to DU RRC Information. The illustrated IE includes the RRC Information that are sent from gNB-CU to gNB-DU. FIG. 8 is a table illustrating an example of DU to CU RRC Information. The illustrated IE includes the RRC Information that are sent from the gNB-DU to the gNB-CU. In some examples, the CU to DU RRC Information and DU to CU RRC Information are sent in F1AP, as part of the UE context setup and modification procedures. FIG. 9 illustrates an example of the supported gap patterns in NR.

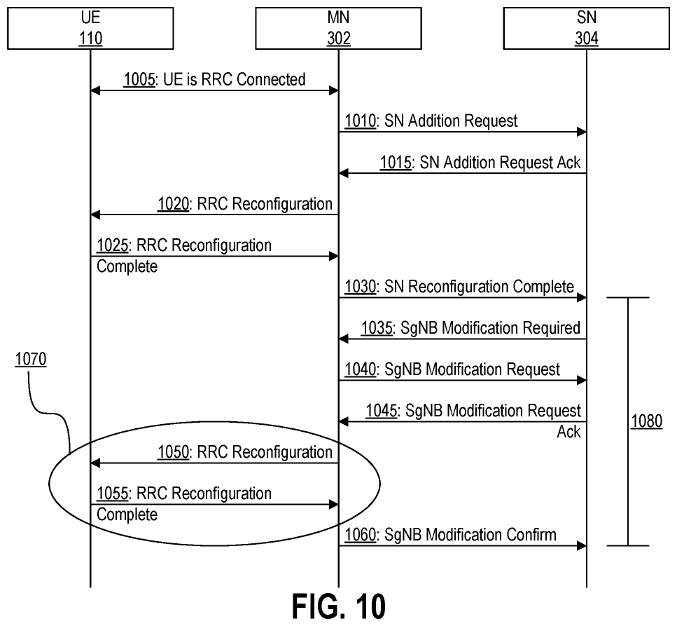

There currently exist certain challenges. In some examples, the SN cannot request MN to configure measurement gaps as part of the SN Addition. Instead, as illustrated in FIG. 10, the SN must wait for the SN Addition procedure to be completed, and the UE reconfigured (an additional reconfiguration 1070), before it can request the MN to configure a measurement gap. The result is that the UE needs to be reconfigured twice, and there is a delay 1080 in eventual measurement reports from the UE. At operation 1005, UE 110 is RRC connected to the MN 302. At operation 1010, the MN 302 transmits a SN Addition Request to the SN 304. At operation 1015, the SN 304 transmits a SN Addition Request Acknowledge to the MN 302. At operation 1020, the MN 302 transmits the RRC Reconfiguration to the UE 110. At operation 1025, the UE 110 transmits the RRC Reconfiguration Complete to the MN 302. A delay 1080 can then be observed as operations 1030, 1035, 1040, 1045, 1050, 1055, and 1060 are performed before a measurement gap is properly set up. At operation 1030, the MN 302 transmits a SN Reconfiguration Complete to the SN 304. At operation 1035, the SN 304 transmits a SgNB Modification Required to the MN 302. At operation 1040, the MN 302 transmits a SgNB Modification Request to the SN 304. At operation 1045, the SN 304 transmits a SgNB Modification Request Acknowledge to the MN 302. The second reconfiguration procedure 1070 is then performed by operations 1050 and 1055. At operation 1060, the MN 302 transmits a SgNB Modification Confirmation.

In some examples, if the SN would request measurements with the purpose of setting up carrier aggregation, the report would be delayed, and thus the setting up of carrier aggregation delayed as well.

In additional or alternative examples, once DC has been set up, if the MN initiates a modification, the SN cannot decide to include measurements including measurement gaps in the same RRC modification toward the UE.

In a split architecture, the gNB-CU may only indicate the measurement configuration and not the measurement purpose. For example, in case of poor coverage, different gap pattern might be beneficial, as the repetition period of the gap pattern will impact the time it takes for the UE to perform the measurements and report them to the network.

Currently, gNB-CU can only report measConfig, including the measObjectNR. Each measObjectNR includes an synchronization signal block based measurement timing configuration (“SMTC”) including timing (periodicity of the synchronization signal block (“SSB”)), but that information alone is not enough for the gNB-DU to make a good decision on which gap pattern to use.

Certain aspects of the disclosure and their embodiments may provide solutions to these or other challenges. In some embodiments, the MN can provide candidate measurement gaps configurations as part of the SN Addition. The SN can accept one measurement gap configuration if it needs gaps at addition, or none if gaps are not of interest. The MN can also provide candidate measurement gaps in SN Modification initiated by MN. In split architecture, gNB-CU can influence the decision of the measurement gap pattern used by gNB-DU.

Certain embodiments may provide one or more of the following technical advantages. In some embodiments, SN requested measurement gaps at SN Addition can reduce a number of RRC reconfigurations; expedite SN configured measurements, resulting in, for example, faster setup of measurement-based carrier aggregation; and increased capacity to optimize the gap pattern used.

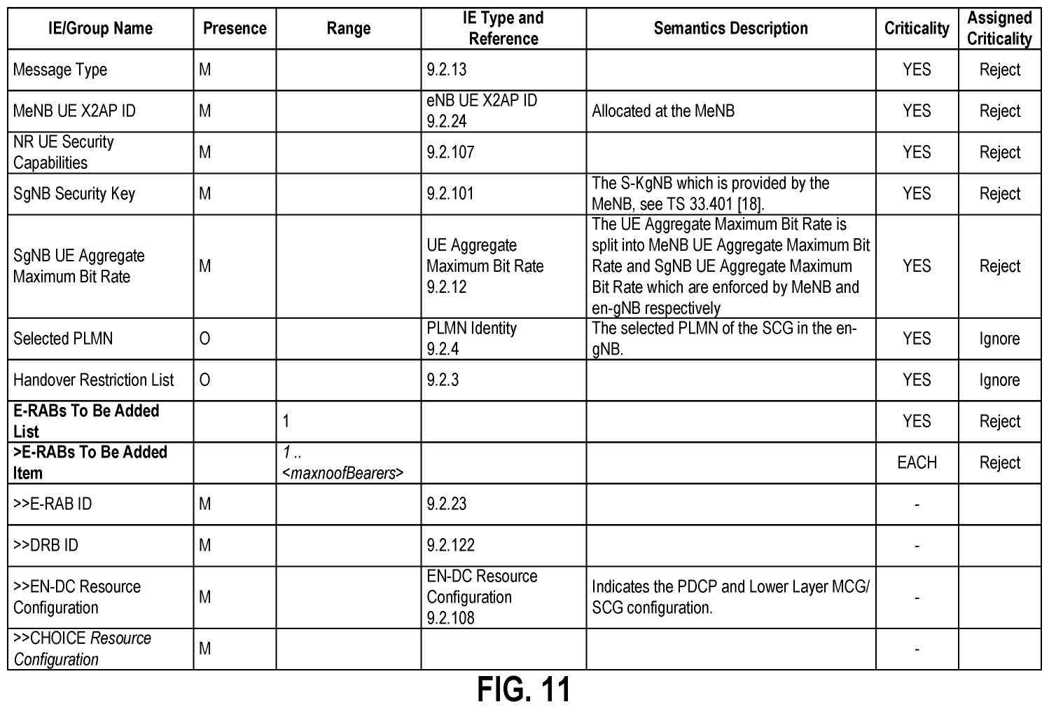

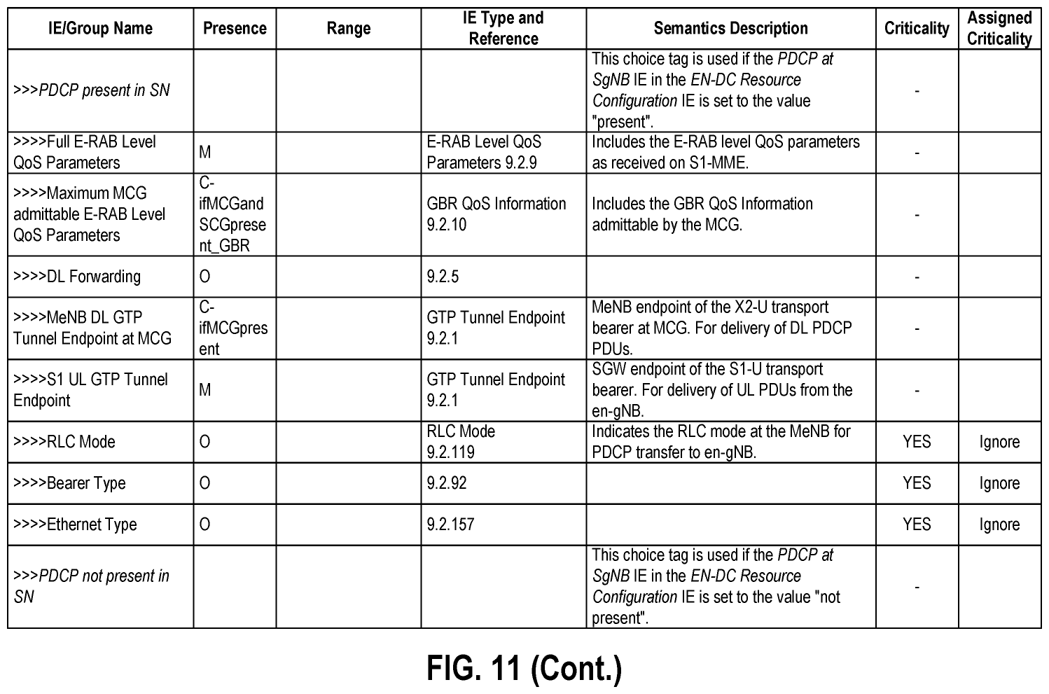

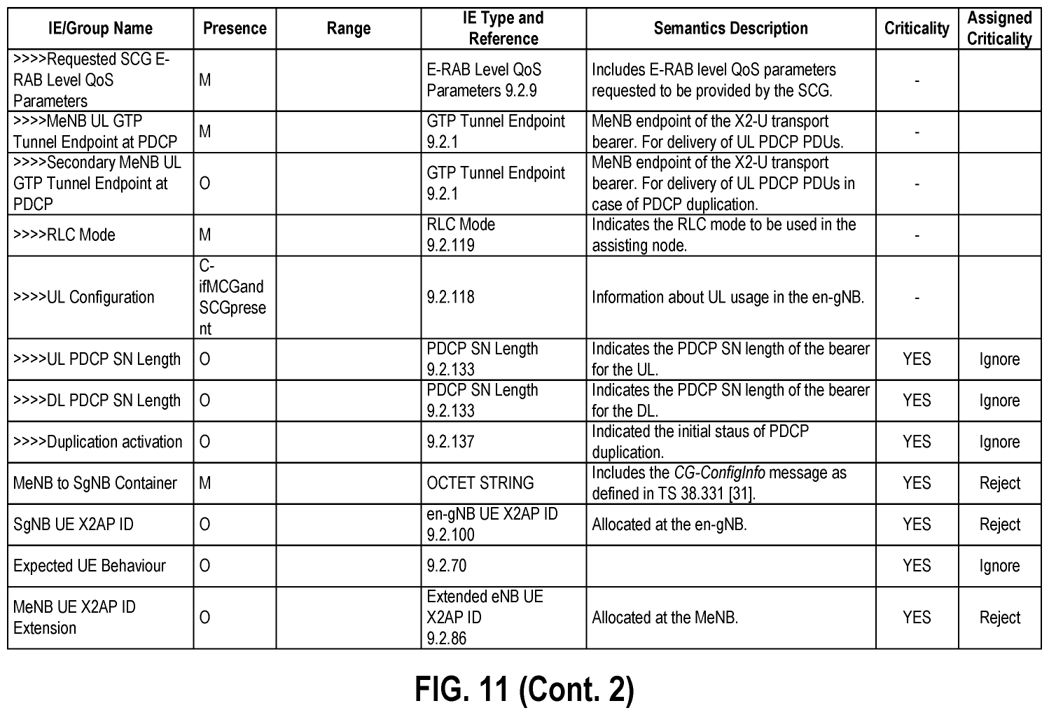

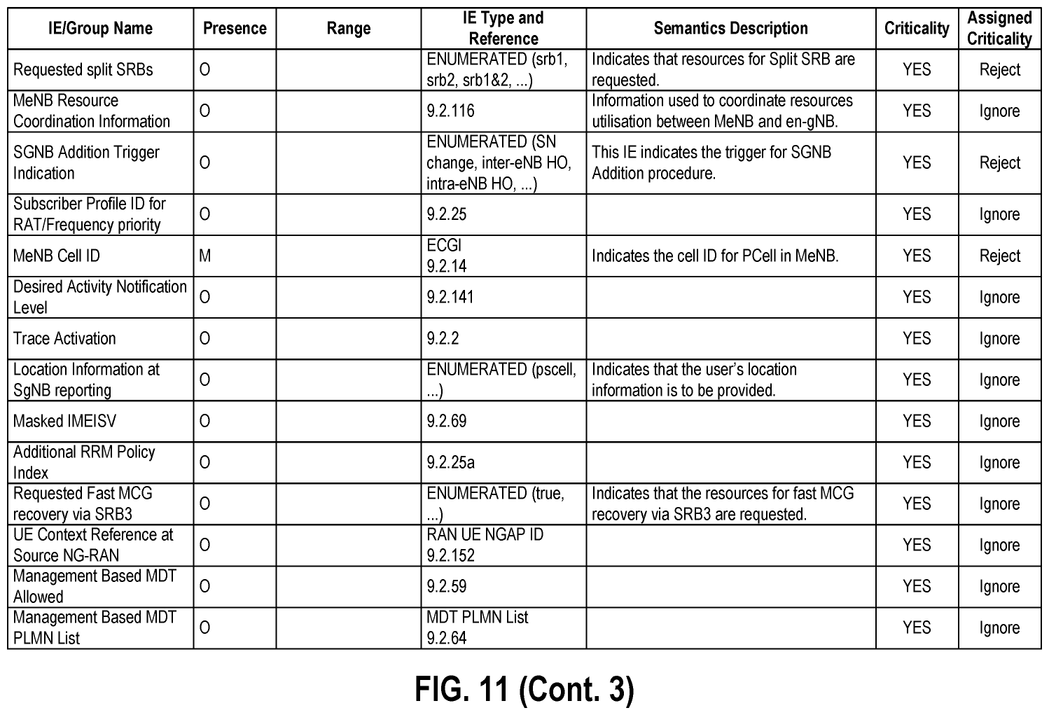

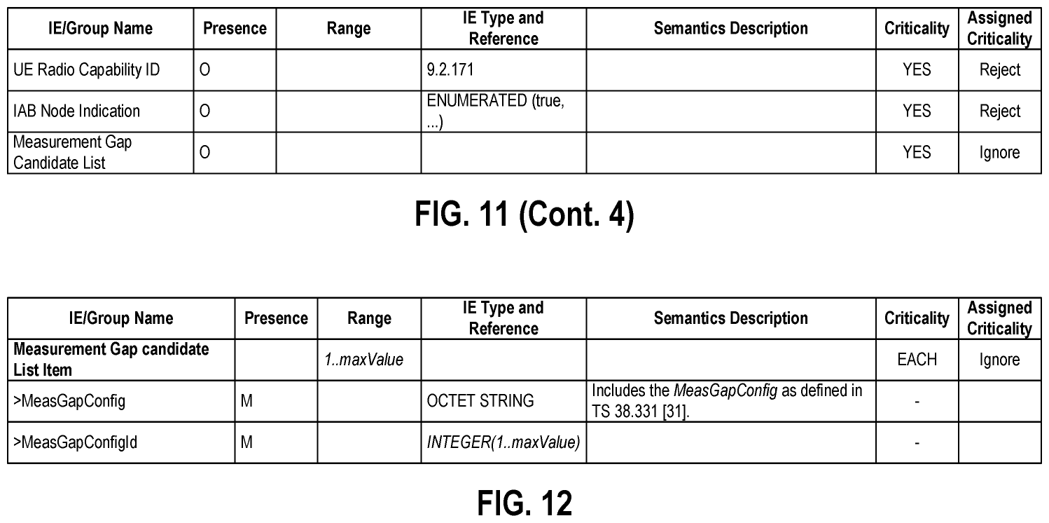

In some embodiments, a MN provides a list of candidate measurement gaps as part of the SN Addition procedure. The list of candidate measurement gaps includes the gap pattern and a selected offset. As an example, for EN-DC, the SgNB Addition includes (referring to X2AP) the SgNB Addition Request illustrated in FIG. 11. The SgNB Addition Request is a message sent by the MeNB to the en-gNB to request the preparation of resources for EN-DC operation for a specific UE. FIG. 12 is a table illustrating an example of a Measurement Gap candidate List. The IE includes a list of evolved packet system radio access bearer (“E-RAB”) identities with a cause value. It is used for example to indicate not admitted bearers.

The SN can, in the SN Addition Request Acknowledge, provide the MeasGapConfigId, to indicate which gap pattern the SN has selected. Alternatively, MeasGapConfigId is omitted, and the SN provides the MeasGapConfig IE in the response, indicating the MN which gap pattern the SN wants.

Based on this response, the MN configures the measurement gap toward the UE, and the SN understands that the measurement gap is applied. The MN can indicate if the configuration of the measurement gap is optional (decided by SN) or if the measurement gap is mandatory (needed by MN) but SN can select the gap pattern.

In some embodiments, this is indicated in two ways, depending on the alternative: (1) By configuring MeasConfigMN including a measurement gap and Measurement Gap Candidate List; and (2) By providing an additional IE in Measurement Gap Candidate List or some new IE indicating which type of measurement gap is to be selected.

If no gap is required by MN, the SN can indicate that it is not interested in a gap by not providing an indication to the MN.

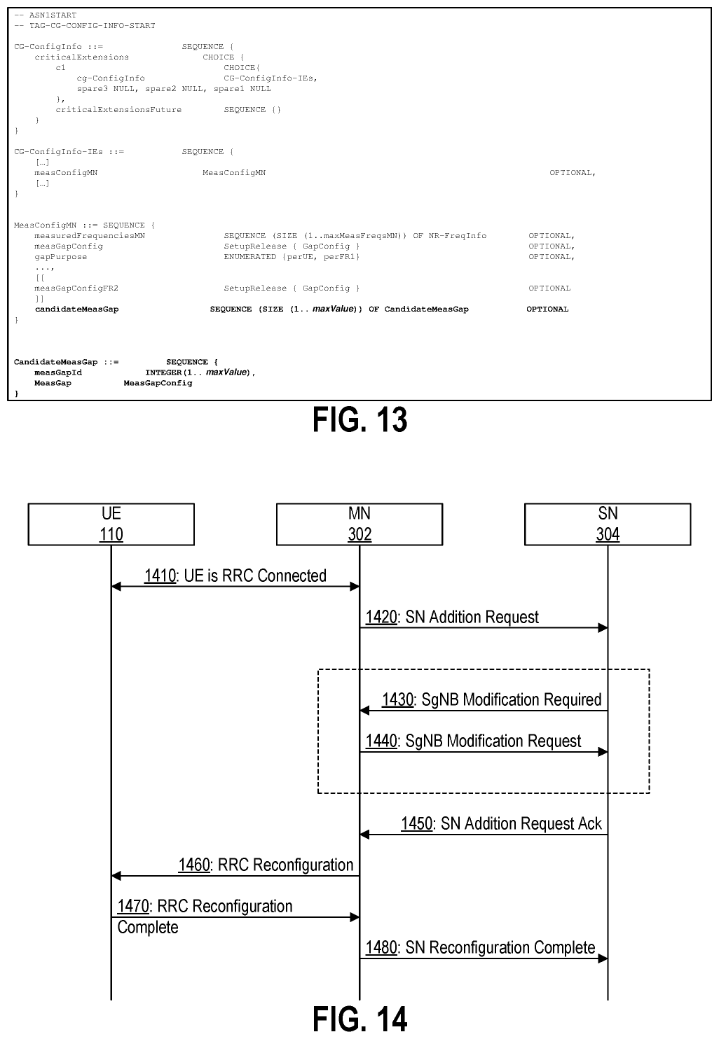

In additional or alternative embodiments, the list is provided as part of the cg-ConfigInfo in the SN Addition and MN initiated SN Modification. FIG. 13 illustrates an example of the cg-ConfigInfo message including the list. In response to the cg-ConfigInfo, the SN can answer indicating either the measGapId or the MeasGapConfig as part of the response to the MN.

In additional or alternative embodiments, as illustrated in FIG. 14, as part of the SN Addition procedure, the SN can request the MN of measurement gaps by initiating a SgNB initiated SgNB Modification.

At operation 1410, the UE 110 is RRC connected to the MN 302. At operation 1420, the MN 302 transmits a SN Addition Request to the SN 304. Once the SN receives the SN Addition Request, the SN can request a measurement gap configuration as part of the SgNB Modification Required (operation 1430), to which the master gNB in DC (“MgNB”) can respond with a SgNB Modification Request (operation 1440) with or without measurement gaps. At operation 1450, the SN 304 transmits a SN Addition Request Acknowledgement. At operations 1460 and 1470, the RRC reconfiguration procedure is performed (only one time compared to twice in FIG. 10). At operation 1480, the MN 302 transmits a SN Reconfiguration Complete to the SN 304 (which as seen is with much less delay than in FIG. 10).

In some embodiments, if the gNB supports split architecture, the MgNB-CU is able to request MgNB-DU to propose multiple candidate measurement gaps, as part of the F1AP UE Context Setup or Modification Request. The request from MgNB-CU can be an IE indicating to generate one or multiple candidates, or a request including additional information including for example if the gap configuration should be perFR1, perFR2, a mix of perFR1 and perFr2 or perUE. The MgNB-DU responds with a list of candidate gaps, from which the MgNB-CU or the SN decides to use one of them when reconfiguring the UE. In some examples, if the SN performs the selection, the MgNB-CU is informed of which gap pattern is select as explained in earlier embodiments.

In additional or alternative embodiments, once the UE has been reconfigured, the MgNB-CU indicates the MgNB-DU which measGapConfig was applied as part of the same F1AP UE Context Modification including the IE “Reconfiguration Complete Indication”, or in a separate F1AP UE Context Modification before IE “Reconfiguration Complete Indication” is signaled, for the purpose of indicating the selected gap pattern.

In additional or alternative embodiments, in the SgNB, the list of candidate measurement gaps is received by SgNB-CU and/or SgNB-DU. In some examples, the decision is performed in the SgNB-CU. The SgNB-CU then indicates the gNB-DU which measurement gap pattern in the measConfigMN IE inside the cg-ConfigInfo. In additional or alternative examples, the SgNB-CU then indicates the MN which measGapConfig was selected.

In other examples, the decision is performed in the SgNB-DU. The SgNB-DU indicates the SgNB-CU which meas configuration is selected, via the “measGapConfig” IE in “DU to CU RRC Information” or via a new IE introduced to indicate the measGapConfigId as explained in a previous embodiment.

In additional or alternative embodiments, when the gNB supports splits architecture and is not related to dual connectivity, the gNB-CU is able to request gNB-DU to propose multiple candidate measurement gaps, as part of the F1AP UE Context Setup or Modification Request. The request from gNB-CU can be a IE indicating to generate one or multiple candidates, or a request including additional information including for example if the gap configuration should be perFR1, perFR2, a mix of perFR1 and perFr2 or perUE. The gNB-DU can respond with a list of candidate gaps, from which the gNB-CU decides to use one of them when reconfiguring the UE.

In additional or alternative embodiments, once the UE has been reconfigured, the gNB-CU indicates to the gNB-DU which measGapConfig was applied as part of the same F1AP UE Context Modification including the IE “Reconfiguration Complete Indication”, or in a separate F1AP UE Context Modification before IE “Reconfiguration Complete Indication” is signaled, for the purpose of indicating the selected gap pattern.

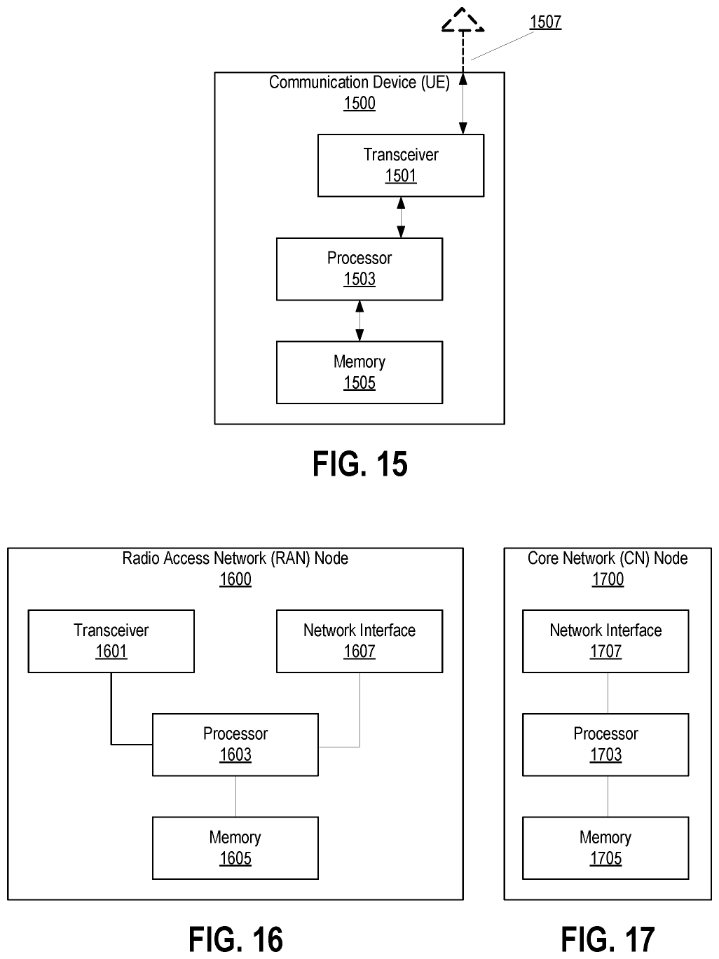

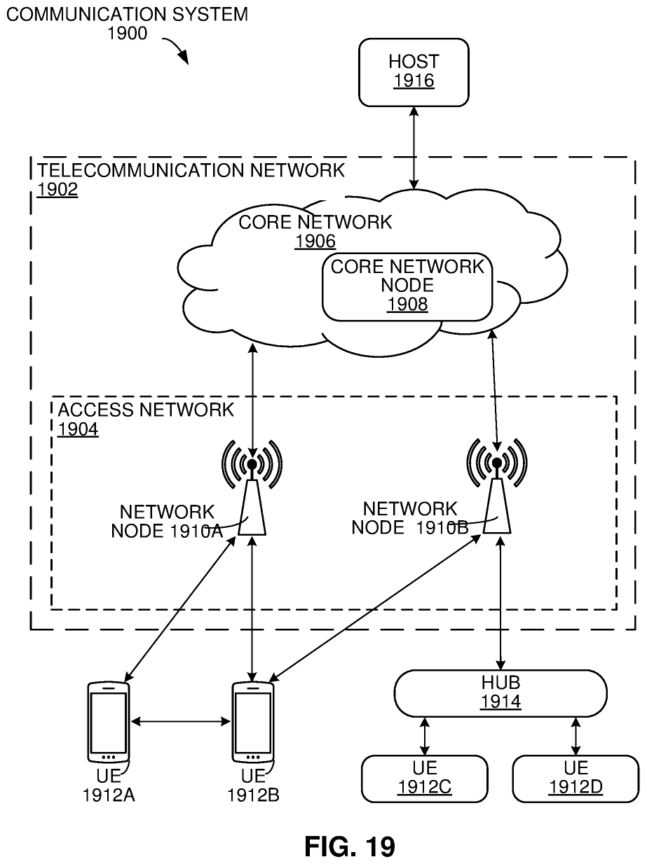

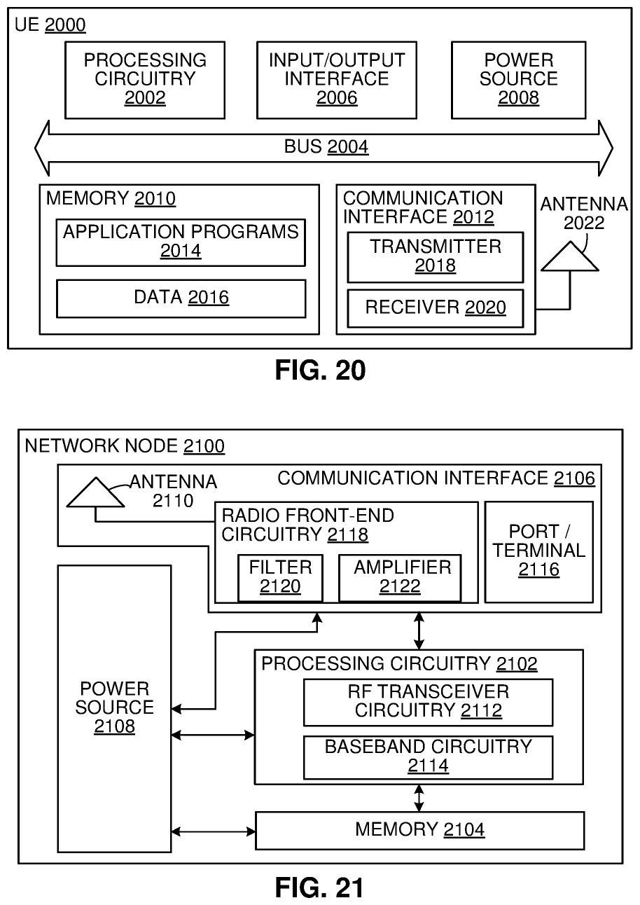

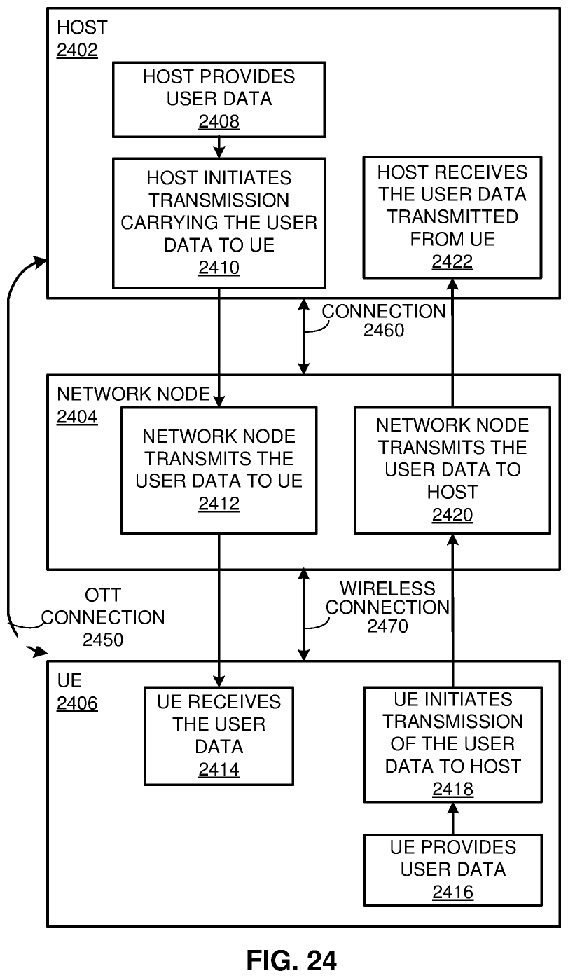

FIG. 15 is a block diagram illustrating elements of a communication device 1500 (also referred to as a mobile terminal, a mobile communication terminal, a wireless device, a wireless communication device, a wireless terminal, mobile device, a wireless communication terminal, user equipment (“UE”) a user equipment node/terminal/device, etc.) configured to provide wireless communication according to embodiments of inventive concepts. (Communication device 1500 may be provided, for example, as discussed below with respect to wireless devices UE 1912A, UE 1912B, and wired or wireless devices UE 1912C, UE 1912D of FIG. 19, UE 2000 of FIG. 20, virtualization hardware 2304 and virtual machines 2308A, 2308B of FIG. 23, and UE 2406 of FIG. 24, all of which should be considered interchangeable in the examples and embodiments described herein and be within the intended scope of this disclosure, unless otherwise noted.) As shown, communication device 500 may include an antenna 1507 (e.g., corresponding to antenna 2022 of FIG. 20), and transceiver circuitry 1501 (also referred to as a transceiver, e.g., corresponding to interface 2012 of FIG. 20 having transmitter 2018 and receiver 2020) including a transmitter and a receiver configured to provide uplink and downlink radio communications with a base station(s) (e.g., corresponding to network node 1910A, 1910B of FIG. 19, network node 2100 of FIG. 21, and network node 2404 of FIG. 24 also referred to as a RAN node) of a radio access network. communication device 1500 may also include processing circuitry 1503 (also referred to as a processor, e.g., corresponding to processing circuitry 2002 of FIG. 20, and control system 2312 of FIG. 23) coupled to the transceiver circuitry, and memory circuitry 1505 (also referred to as memory, e.g., corresponding to memory 2010 of FIG. 19) coupled to the processing circuitry 1503. The memory circuitry 1505 may include computer readable program code that when executed by the processing circuitry 1503 causes the processing circuitry 1503 to perform operations according to embodiments disclosed herein. According to other embodiments, processing circuitry 1503 may be defined to include memory so that separate memory circuitry is not required. Communication device 1500 may also include an interface (such as a user interface) coupled with processing circuitry 1503, and/or communication device 1500 may be incorporated in a vehicle.

As discussed herein, operations of communication device 1500 may be performed by processing circuitry 1503 and/or transceiver circuitry 1501. For example, processing circuitry 1503 may control transceiver circuitry 1501 to transmit communications through transceiver circuitry 1501 over a radio interface to a radio access network node (also referred to as a base station) and/or to receive communications through transceiver circuitry 1501 from a RAN node over a radio interface. Moreover, modules may be stored in memory circuitry 1505, and these modules may provide instructions so that when instructions of a module are executed by processing circuitry 1503, processing circuitry 1503 performs respective operations. According to some embodiments, a communication device 1500 and/or an element(s)/function(s) thereof may be embodied as a virtual node/nodes and/or a virtual machine/machines.

FIG. 16 is a block diagram illustrating elements of a radio access network (“RAN”) node 1600 (also referred to as a network node, base station, eNodeB/eNB, gNodeB/gNB, etc.) of a RAN configured to provide cellular communication according to embodiments of inventive concepts. (RAN node 1600 may be provided, for example, as discussed below with respect to network node 1910A, 1910B of FIG. 19, network node 2100 of FIG. 21, hardware 2304 or virtual machine 2308A, 2308B of FIG. 23, and/or base station 2404 of FIG. 24, all of which should be considered interchangeable in the examples and embodiments described herein and be within the intended scope of this disclosure, unless otherwise noted.) As shown, the RAN node 1600 may include transceiver circuitry 1601 (also referred to as a transceiver, e.g., corresponding to portions of RF transceiver circuitry 2112 and radio front end circuitry 2118 of FIG. 21) including a transmitter and a receiver configured to provide uplink and downlink radio communications with mobile terminals. The RAN node 1600 may include network interface circuitry 1607 (also referred to as a network interface, e.g., corresponding to portions of communication interface 2106 of FIG. 21) configured to provide communications with other nodes (e.g., with other base stations) of the RAN and/or core network (“CN”). The network node 1600 may also include processing circuitry 1603 (also referred to as a processor, e.g., corresponding to processing circuitry 2102 of FIG. 21) coupled to the transceiver circuitry 1601, and memory circuitry 1605 (also referred to as memory, e.g., corresponding to memory 2104 of FIG. 21) coupled to the processing circuitry. The memory circuitry 1605 may include computer readable program code that when executed by the processing circuitry 1603 causes the processing circuitry 1603 to perform operations according to embodiments disclosed herein. According to other embodiments, processing circuitry 1603 may be defined to include memory so that a separate memory circuitry 1605 is not required.

As discussed herein, operations of the RAN node 1600 may be performed by processing circuitry 1603, network interface 1607, and/or transceiver 1601. For example, processing circuitry 1603 may control transceiver 1601 to transmit downlink communications through transceiver 1601 over a radio interface to one or more mobile terminals UEs and/or to receive uplink communications through transceiver 1601 from one or more mobile terminals UEs over a radio interface. Similarly, processing circuitry 1603 may control network interface 1607 to transmit communications through network interface 1607 to one or more other network nodes and/or to receive communications through network interface from one or more other network nodes. Moreover, modules may be stored in memory 1605, and these modules may provide instructions so that when instructions of a module are executed by processing circuitry 1603, processing circuitry 1603 performs respective operations. According to some embodiments, RAN node 1600 and/or an element(s)/function(s) thereof may be embodied as a virtual node/nodes and/or a virtual machine/machines.

According to some other embodiments, a network node may be implemented as a core network (“CN”) node without a transceiver. In such embodiments, transmission to a wireless communication device UE may be initiated by the CN node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 17 is a block diagram illustrating elements of a CN node (e.g., an SMF (session management function) node, an AMF (access and mobility management function) node, etc.) of a communication network configured to provide cellular communication according to embodiments of inventive concepts. (CN node 1700 may be provided, for example, as discussed below with respect to core network node 1908 of FIG. 19, hardware 2304 or virtual machine 2308A, 2308B of FIG. 23, all of which should be considered interchangeable in the examples and embodiments described herein and be within the intended scope of this disclosure, unless otherwise noted) As shown, the CN node 1700 may include network interface circuitry 1707 configured to provide communications with other nodes of the core network and/or the radio access network RAN. The CN node 1700 may also include a processing circuitry 1703 (also referred to as a processor) coupled to the network interface circuitry, and memory circuitry 1705 (also referred to as memory) coupled to the processing circuitry. The memory circuitry 1705 may include computer readable program code that when executed by the processing circuitry 1703 causes the processing circuitry 1703 to perform operations according to embodiments disclosed herein. According to other embodiments, processing circuitry 1703 may be defined to include memory so that a separate memory circuitry is not required.

As discussed herein, operations of the CN node 1700 may be performed by processing circuitry 1703 and/or network interface circuitry 1707. For example, processing circuitry 1703 may control network interface circuitry 1707 to transmit communications through network interface circuitry 1707 to one or more other network nodes and/or to receive communications through network interface circuitry from one or more other network nodes. Moreover, modules may be stored in memory 1705, and these modules may provide instructions so that when instructions of a module are executed by processing circuitry 1703, processing circuitry 1703 performs respective operations. According to some embodiments, CN node 1700 and/or an element(s)/function(s) thereof may be embodied as a virtual node/nodes and/or a virtual machine/machines.

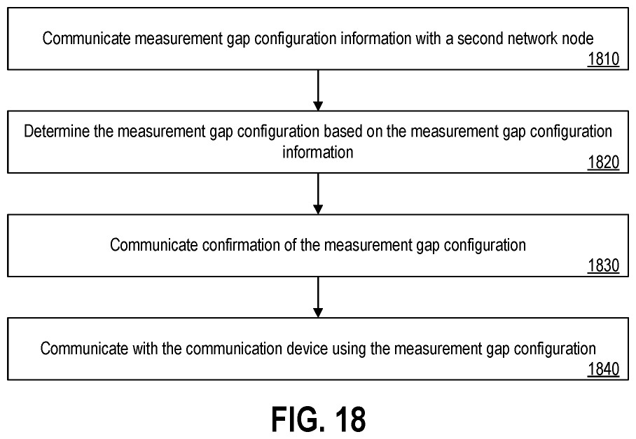

In the description that follows, while the network node may be any of the RAN node 1600, network node 1910A, 1910B, 2100, 2406, hardware 2304, or virtual machine 2308A, 2308B, the RAN node 1600 shall be used to describe the functionality of the operations of the network node. Operations of the RAN node 1600 (implemented using the structure of FIG. 16) will now be discussed with reference to the flow chart of FIG. 18 according to some embodiments of inventive concepts. For example, modules may be stored in memory 1605 of FIG. 16, and these modules may provide instructions so that when the instructions of a module are executed by respective RAN node processing circuitry 1603, processing circuitry 1603 performs respective operations of the flow charts.

FIG. 18 illustrates an example of operations performed by a first network node in a communications network that includes a second network node. One of the first network node and the second network node can be a master node, MN, and the other of the one of the first network node and the second network node can be a secondary node, SN.

At block 1810, processing circuitry 1603 communicates, via network interface 1607, measurement gap configuration information with a second network node. In some embodiments, the measurement gap configuration information is communicated prior the MN performing a RRC reconfiguration with the communication device. In additional or alternative embodiments, communicating the measurement gap configuration information includes communicating the measurement gap configuration information in response to the MN initiating a SN Addition procedure or a Dual Connectivity Setup procedure. In additional or alternative embodiments, communicating the measurement gap configuration information includes communicating the measurement gap configuration information with the SN node in response to a communication device connecting to the MN.

In some embodiments, communicating the measurement gap configuration information includes transmitting an indication of a set of candidate measurement gap configurations to the second network node and receiving an indication of a selected candidate measurement gap configuration of the set of candidate measurement gap configurations from the second network node.

In other embodiments, communicating the measurement gap configuration information includes receiving an indication of a set of candidate measurement gap configurations from the second network node; and transmitting an indication of a selected candidate measurement gap configuration of the set of candidate measurement gap configurations to the second network node.

In additional or alternative embodiments, communicating the measurement gap configuration information includes communicating the measurement gap configuration information as part of a SN Addition procedure or a SgNB Modification procedure.

In additional or alternative embodiments, the measurement gap configuration information includes at least one of: an indication of whether the measurement gap configuration is to be perFR1, perFR2, a mix of perFR1 and perFR2, or perUE; an indication of a condition during which to apply the measurement gap configuration; an indication of a measurement gap pattern; and an indication of whether the measurement gap configuration is mandatory or optional for the MN.

In some examples, the first network node is the MN and the second network node is the SN. In other examples, the first network node is the SN and the second network node is the MN.

At block 1820, processing circuitry 1603 determines the measurement gap configuration based on the measurement gap configuration information.

In some embodiments, the first network node includes a centralized unit, CU, and a distributed unit, DU. In some examples, communicating the measurement gap configuration information includes receiving, by the CU, the measurement gap configuration information from the second node. Determining the measurement gap configuration includes determining, by the DU, the measurement gap configuration based on the measurement gap configuration received from the CU.

At block 1830, processing circuitry 1603 communicates, via network interface 1607, confirmation of the measurement gap configuration.

At block 1840, processing circuitry 1603 communicates, via transceiver 1601, with the communication device using the measurement gap configuration.

Various operations from the flow chart of FIG. 18 may be optional with respect to some embodiments of RAN nodes and related methods. In some examples, operations of blocks 1820 and 1830 of FIG. 18 may be optional.

FIG. 19 shows an example of a communication system 1900 in accordance with some embodiments. In some examples, network nodes 1910A-B are examples of a MN and a SN as described above.

In the example, the communication system 1900 includes a telecommunication network 1902 that includes an access network 1904, such as a radio access network (RAN), and a core network 1906, which includes one or more core network nodes 1908. The access network 1904 includes one or more access network nodes, such as network nodes 1910a and 1910b (one or more of which may be generally referred to as network nodes 1910), or any other similar 3^{rd} Generation Partnership Project (3GPP) access node or non-3GPP access point. The network nodes 1910 facilitate direct or indirect connection of user equipment (UE), such as by connecting UEs 1912a, 1912b, 1912c, and 1912d (one or more of which may be generally referred to as UEs 1912) to the core network 1906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1900 may include any number of wired or wireless networks, network nodes, UEs, and/or any other components or systems that may facilitate or participate in the communication of data and/or signals whether via wired or wireless connections. The communication system 1900 may include and/or interface with any type of communication, telecommunication, data, cellular, radio network, and/or other similar type of system.

The UEs 1912 may be any of a wide variety of communication devices, including wireless devices arranged, configured, and/or operable to communicate wirelessly with the network nodes 1910 and other communication devices. Similarly, the network nodes 1910 are arranged, capable, configured, and/or operable to communicate directly or indirectly with the UEs 1912 and/or with other network nodes or equipment in the telecommunication network 1902 to enable and/or provide network access, such as wireless network access, and/or to perform other functions, such as administration in the telecommunication network 1902.

In the depicted example, the core network 1906 connects the network nodes 1910 to one or more hosts, such as host 1916. These connections may be direct or indirect via one or more intermediary networks or devices. In other examples, network nodes may be directly coupled to hosts. The core network 1906 includes one more core network nodes (e.g., core network node 1908) that are structured with hardware and software components. Features of these components may be substantially similar to those described with respect to the UEs, network nodes, and/or hosts, such that the descriptions thereof are generally applicable to the corresponding components of the core network node 1908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1916 may be under the ownership or control of a service provider other than an operator or provider of the access network 1904 and/or the telecommunication network 1902, and may be operated by the service provider or on behalf of the service provider. The host 1916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1900 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1902 is a cellular network that implements 3GPP standardized features. Accordingly, the telecommunications network 1902 may support network slicing to provide different logical networks to different devices that are connected to the telecommunication network 1902. For example, the telecommunications network 1902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1912 are configured to transmit and/or receive information without direct human interaction. For instance, a UE may be designed to transmit information to the access network 1904 on a predetermined schedule, when triggered by an internal or external event, or in response to requests from the access network 1904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1914 communicates with the access network 1904 to facilitate indirect communication between one or more UEs (e.g., UE 1912c and/or 1912d) and network nodes (e.g., network node 1910b). In some examples, the hub 1914 may be a controller, router, content source and analytics, or any of the other communication devices described herein regarding UEs. For example, the hub 1914 may be a broadband router enabling access to the core network 1906 for the UEs. As another example, the hub 1914 may be a controller that sends commands or instructions to one or more actuators in the UEs. Commands or instructions may be received from the UEs, network nodes 1910, or by executable code, script, process, or other instructions in the hub 1914. As another example, the hub 1914 may be a data collector that acts as temporary storage for UE data and, in some embodiments, may perform analysis or other processing of the data. As another example, the hub 1914 may be a content source. For example, for a UE that is a VR headset, display, loudspeaker or other media delivery device, the hub 1914 may retrieve VR assets, video, audio, or other media or data related to sensory information via a network node, which the hub 1914 then provides to the UE either directly, after performing local processing, and/or after adding additional local content. In still another example, the hub 1914 acts as a proxy server or orchestrator for the UEs, in particular in if one or more of the UEs are low energy IoT devices.

The hub 1914 may have a constant/persistent or intermittent connection to the network node 1910b. The hub 1914 may also allow for a different communication scheme and/or schedule between the hub 1914 and UEs (e.g., UE 1912c and/or 1912d), and between the hub 1914 and the core network 1906. In other examples, the hub 1914 is connected to the core network 1906 and/or one or more UEs via a wired connection. Moreover, the hub 1914 may be configured to connect to an M2M service provider over the access network 1904 and/or to another UE over a direct connection. In some scenarios, UEs may establish a wireless connection with the network nodes 1910 while still connected via the hub 1914 via a wired or wireless connection. In some embodiments, the hub 1914 may be a dedicated hub—that is, a hub whose primary function is to route communications to/from the UEs from/to the network node 1910b. In other embodiments, the hub 1914 may be a non-dedicated hub—that is, a device which is capable of operating to route communications between the UEs and network node 1910b, but which is additionally capable of operating as a communication start and/or end point for certain data channels.

FIG. 20 shows a UE 2000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2000 includes processing circuitry 2002 that is operatively coupled via a bus 2004 to an input/output interface 2006, a power source 2008, a memory 2010, a communication interface 2012, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

The processing circuitry 2002 is configured to process instructions and data and may be configured to implement any sequential state machine operative to execute instructions stored as machine-readable computer programs in the memory 2010. The processing circuitry 2002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2002 may include multiple central processing units (CPUs).

In the example, the input/output interface 2006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2008 is structured as a battery or battery pack. Other types of power sources, such as an external power source (e.g., an electricity outlet), photovoltaic device, or power cell, may be used. The power source 2008 may further include power circuitry for delivering power from the power source 2008 itself, and/or an external power source, to the various parts of the UE 2000 via input circuitry or an interface such as an electrical power cable. Delivering power may be, for example, for charging of the power source 2008. Power circuitry may perform any formatting, converting, or other modification to the power from the power source 2008 to make the power suitable for the respective components of the UE 2000 to which power is supplied.

The memory 2010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2010 includes one or more application programs 2014, such as an operating system, web browser application, a widget, gadget engine, or other application, and corresponding data 2016. The memory 2010 may store, for use by the UE 2000, any of a variety of various operating systems or combinations of operating systems.

The memory 2010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2010 may allow the UE 2000 to access instructions, application programs and the like, stored on transitory or non-transitory memory media, to off-load data, or to upload data. An article of manufacture, such as one utilizing a communication system may be tangibly embodied as or in the memory 2010, which may be or comprise a device-readable storage medium.

The processing circuitry 2002 may be configured to communicate with an access network or other network using the communication interface 2012. The communication interface 2012 may comprise one or more communication subsystems and may include or be communicatively coupled to an antenna 2022. The communication interface 2012 may include one or more transceivers used to communicate, such as by communicating with one or more remote transceivers of another device capable of wireless communication (e.g., another UE or a network node in an access network). Each transceiver may include a transmitter 2018 and/or a receiver 2020 appropriate to provide network communications (e.g., optical, electrical, frequency allocations, and so forth). Moreover, the transmitter 2018 and receiver 2020 may be coupled to one or more antennas (e.g., antenna 2022) and may share circuit components, software or firmware, or alternatively be implemented separately.

In the illustrated embodiment, communication functions of the communication interface 2012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2000 shown in FIG. 20.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node 2100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2100 includes a processing circuitry 2102, a memory 2104, a communication interface 2106, and a power source 2108. The network node 2100 may be composed of multiple physically separate components (e.g., a NodeB component and a RNC component, or a BTS component and a BSC component, etc.), which may each have their own respective components. In certain scenarios in which the network node 2100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2100 may be configured to support multiple radio access technologies (RATs). In such embodiments, some components may be duplicated (e.g., separate memory 2104 for different RATs) and some components may be reused (e.g., a same antenna 2110 may be shared by different RATs). The network node 2100 may also include multiple sets of the various illustrated components for different wireless technologies integrated into network node 2100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2100.

The processing circuitry 2102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2100 components, such as the memory 2104, to provide network node 2100 functionality.

In some embodiments, the processing circuitry 2102 includes a system on a chip (SOC). In some embodiments, the processing circuitry 2102 includes one or more of radio frequency (RF) transceiver circuitry 2112 and baseband processing circuitry 2114. In some embodiments, the radio frequency (RF) transceiver circuitry 2112 and the baseband processing circuitry 2114 may be on separate chips (or sets of chips), boards, or units, such as radio units and digital units. In alternative embodiments, part or all of RF transceiver circuitry 2112 and baseband processing circuitry 2114 may be on the same chip or set of chips, boards, or units.

The memory 2104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2102. The memory 2104 may store any suitable instructions, data, or information, including a computer program, software, an application including one or more of logic, rules, code, tables, and/or other instructions capable of being executed by the processing circuitry 2102 and utilized by the network node 2100. The memory 2104 may be used to store any calculations made by the processing circuitry 2102 and/or any data received via the communication interface 2106. In some embodiments, the processing circuitry 2102 and memory 2104 is integrated.

The communication interface 2106 is used in wired or wireless communication of signaling and/or data between a network node, access network, and/or UE. As illustrated, the communication interface 2106 comprises port(s)/terminal(s) 2116 to send and receive data, for example to and from a network over a wired connection. The communication interface 2106 also includes radio front-end circuitry 2118 that may be coupled to, or in certain embodiments a part of, the antenna 2110. Radio front-end circuitry 2118 comprises filters 2120 and amplifiers 2122. The radio front-end circuitry 2118 may be connected to an antenna 2110 and processing circuitry 2102. The radio front-end circuitry may be configured to condition signals communicated between antenna 2110 and processing circuitry 2102. The radio front-end circuitry 2118 may receive digital data that is to be sent out to other network nodes or UEs via a wireless connection. The radio front-end circuitry 2118 may convert the digital data into a radio signal having the appropriate channel and bandwidth parameters using a combination of filters 2120 and/or amplifiers 2122. The radio signal may then be transmitted via the antenna 2110. Similarly, when receiving data, the antenna 2110 may collect radio signals which are then converted into digital data by the radio front-end circuitry 2118. The digital data may be passed to the processing circuitry 2102. In other embodiments, the communication interface may comprise different components and/or different combinations of components.

In certain alternative embodiments, the network node 2100 does not include separate radio front-end circuitry 2118, instead, the processing circuitry 2102 includes radio front-end circuitry and is connected to the antenna 2110. Similarly, in some embodiments, all or some of the RF transceiver circuitry 2112 is part of the communication interface 2106. In still other embodiments, the communication interface 2106 includes one or more ports or terminals 2116, the radio front-end circuitry 2118, and the RF transceiver circuitry 2112, as part of a radio unit (not shown), and the communication interface 2106 communicates with the baseband processing circuitry 2114, which is part of a digital unit (not shown).

The antenna 2110 may include one or more antennas, or antenna arrays, configured to send and/or receive wireless signals. The antenna 2110 may be coupled to the radio front-end circuitry 2118 and may be any type of antenna capable of transmitting and receiving data and/or signals wirelessly. In certain embodiments, the antenna 2110 is separate from the network node 2100 and connectable to the network node 2100 through an interface or port.

The antenna 2110, communication interface 2106, and/or the processing circuitry 2102 may be configured to perform any receiving operations and/or certain obtaining operations described herein as being performed by the network node. Any information, data and/or signals may be received from a UE, another network node and/or any other network equipment. Similarly, the antenna 2110, the communication interface 2106, and/or the processing circuitry 2102 may be configured to perform any transmitting operations described herein as being performed by the network node. Any information, data and/or signals may be transmitted to a UE, another network node and/or any other network equipment.

The power source 2108 provides power to the various components of network node 2100 in a form suitable for the respective components (e.g., at a voltage and current level needed for each respective component). The power source 2108 may further comprise, or be coupled to, power management circuitry to supply the components of the network node 2100 with power for performing the functionality described herein. For example, the network node 2100 may be connectable to an external power source (e.g., the power grid, an electricity outlet) via an input circuitry or interface such as an electrical cable, whereby the external power source supplies power to power circuitry of the power source 2108. As a further example, the power source 2108 may comprise a source of power in the form of a battery or battery pack which is connected to, or integrated in, power circuitry. The battery may provide backup power should the external power source fail.

Embodiments of the network node 2100 may include additional components beyond those shown in FIG. 21 for providing certain aspects of the network node's functionality, including any of the functionality described herein and/or any functionality necessary to support the subject matter described herein. For example, the network node 2100 may include user interface equipment to allow input of information into the network node 2100 and to allow output of information from the network node 2100. This may allow a user to perform diagnostic, maintenance, repair, and other administrative functions for the network node 2100.

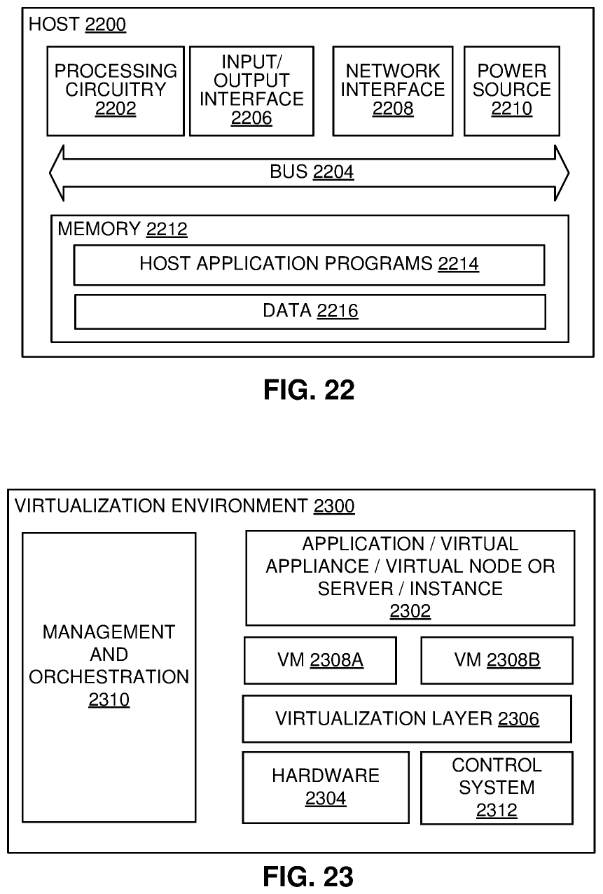

FIG. 22 is a block diagram of a host 2200, which may be an embodiment of the host 1916 of FIG. 19, in accordance with various aspects described herein. As used herein, the host 2200 may be or comprise various combinations hardware and/or software, including a standalone server, a blade server, a cloud-implemented server, a distributed server, a virtual machine, container, or processing resources in a server farm. The host 2200 may provide one or more services to one or more UEs.

The host 2200 includes processing circuitry 2202 that is operatively coupled via a bus 2204 to an input/output interface 2206, a network interface 2208, a power source 2210, and a memory 2212. Other components may be included in other embodiments. Features of these components may be substantially similar to those described with respect to the devices of previous figures, such as FIGS. 20 and 21, such that the descriptions thereof are generally applicable to the corresponding components of host 2200.

The memory 2212 may include one or more computer programs including one or more host application programs 2214 and data 2216, which may include user data, e.g., data generated by a UE for the host 2200 or data generated by the host 2200 for a UE. Embodiments of the host 2200 may utilize only a subset or all of the components shown. The host application programs 2214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2214 may also provide for user authentication and licensing checks and may periodically report health, routes, and content availability to a central node, such as a device in or on the edge of a core network. Accordingly, the host 2200 may select and/or indicate a different host for over-the-top services for a UE. The host application programs 2214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment 2300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2306 (also referred to as hypervisors or virtual machine monitors (VMMs)), provide VMs 2308a and 2308b (one or more of which may be generally referred to as VMs 2308), and/or perform any of the functions, features and/or benefits described in relation with some embodiments described herein. The virtualization layer 2306 may present a virtual operating platform that appears like networking hardware to the VMs 2308.

The VMs 2308 comprise virtual processing, virtual memory, virtual networking or interface and virtual storage, and may be run by a corresponding virtualization layer 2306. Different embodiments of the instance of a virtual appliance 2302 may be implemented on one or more of VMs 2308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2308 may be a software implementation of a physical machine that runs programs as if they were executing on a physical, non-virtualized machine. Each of the VMs 2308, and that part of hardware 2304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2308 on top of the hardware 2304 and corresponds to the application 2302.

Hardware 2304 may be implemented in a standalone network node with generic or specific components. Hardware 2304 may implement some functions via virtualization. Alternatively, hardware 2304 may be part of a larger cluster of hardware (e.g. such as in a data center or CPE) where many hardware nodes work together and are managed via management and orchestration 2310, which, among others, oversees lifecycle management of applications 2302. In some embodiments, hardware 2304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2312 which may alternatively be used for communication between hardware nodes and radio units.

FIG. 24 shows a communication diagram of a host 2402 communicating via a network node 2404 with a UE 2406 over a partially wireless connection in accordance with some embodiments. Example implementations, in accordance with various embodiments, of the UE (such as a UE 1912a of FIG. 19 and/or UE 2000 of FIG. 20), network node (such as network node 1910a of FIG. 19 and/or network node 2100 of FIG. 21), and host (such as host 1916 of FIG. 19 and/or host 2200 of FIG. 22) discussed in the preceding paragraphs will now be described with reference to FIG. 24.

Like host 2200, embodiments of host 2402 include hardware, such as a communication interface, processing circuitry, and memory. The host 2402 also includes software, which is stored in or accessible by the host 2402 and executable by the processing circuitry. The software includes a host application that may be operable to provide a service to a remote user, such as the UE 2406 connecting via an over-the-top (OTT) connection 2450 extending between the UE 2406 and host 2402. In providing the service to the remote user, a host application may provide user data which is transmitted using the OTT connection 2450.

The network node 2404 includes hardware enabling it to communicate with the host 2402 and UE 2406. The connection 2460 may be direct or pass through a core network (like core network 1906 of FIG. 19) and/or one or more other intermediate networks, such as one or more public, private, or hosted networks. For example, an intermediate network may be a backbone network or the Internet.

The UE 2406 includes hardware and software, which is stored in or accessible by UE 2406 and executable by the UE's processing circuitry. The software includes a client application, such as a web browser or operator-specific “app” that may be operable to provide a service to a human or non-human user via UE 2406 with the support of the host 2402. In the host 2402, an executing host application may communicate with the executing client application via the OTT connection 2450 terminating at the UE 2406 and host 2402. In providing the service to the user, the UE's client application may receive request data from the host's host application and provide user data in response to the request data. The OTT connection 2450 may transfer both the request data and the user data. The UE's client application may interact with the user to generate the user data that it provides to the host application through the OTT connection 2450.

The OTT connection 2450 may extend via a connection 2460 between the host 2402 and the network node 2404 and via a wireless connection 2470 between the network node 2404 and the UE 2406 to provide the connection between the host 2402 and the UE 2406. The connection 2460 and wireless connection 2470, over which the OTT connection 2450 may be provided, have been drawn abstractly to illustrate the communication between the host 2402 and the UE 2406 via the network node 2404, without explicit reference to any intermediary devices and the precise routing of messages via these devices.

As an example of transmitting data via the OTT connection 2450, in step 2408, the host 2402 provides user data, which may be performed by executing a host application. In some embodiments, the user data is associated with a particular human user interacting with the UE 2406. In other embodiments, the user data is associated with a UE 2406 that shares data with the host 2402 without explicit human interaction. In step 2410, the host 2402 initiates a transmission carrying the user data towards the UE 2406. The host 2402 may initiate the transmission responsive to a request transmitted by the UE 2406. The request may be caused by human interaction with the UE 2406 or by operation of the client application executing on the UE 2406. The transmission may pass via the network node 2404, in accordance with the teachings of the embodiments described throughout this disclosure. Accordingly, in step 2412, the network node 2404 transmits to the UE 2406 the user data that was carried in the transmission that the host 2402 initiated, in accordance with the teachings of the embodiments described throughout this disclosure. In step 2414, the UE 2406 receives the user data carried in the transmission, which may be performed by a client application executed on the UE 2406 associated with the host application executed by the host 2402.

In some examples, the UE 2406 executes a client application which provides user data to the host 2402. The user data may be provided in reaction or response to the data received from the host 2402. Accordingly, in step 2416, the UE 2406 may provide user data, which may be performed by executing the client application. In providing the user data, the client application may further consider user input received from the user via an input/output interface of the UE 2406. Regardless of the specific manner in which the user data was provided, the UE 2406 initiates, in step 2418, transmission of the user data towards the host 2402 via the network node 2404. In step 2420, in accordance with the teachings of the embodiments described throughout this disclosure, the network node 2404 receives user data from the UE 2406 and initiates transmission of the received user data towards the host 2402. In step 2422, the host 2402 receives the user data carried in the transmission initiated by the UE 2406.

One or more of the various embodiments improve the performance of OTT services provided to the UE 2406 using the OTT connection 2450, in which the wireless connection 2470 forms the last segment. More precisely, the teachings of these embodiments may allow SN requested measurement gaps at SN Addition, and thereby reduce a number of RRC reconfigurations; expedite SN configured measurements, resulting in, for example, faster setup of measurement-based carrier aggregation; and increased capacity to optimize the gap pattern used.

In an example scenario, factory status information may be collected and analyzed by the host 2402. As another example, the host 2402 may process audio and video data which may have been retrieved from a UE for use in creating maps. As another example, the host 2402 may collect and analyze real-time data to assist in controlling vehicle congestion (e.g., controlling traffic lights). As another example, the host 2402 may store surveillance video uploaded by a UE. As another example, the host 2402 may store or control access to media content such as video, audio, VR or AR which it can broadcast, multicast or unicast to UEs. As other examples, the host 2402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2450 between the host 2402 and UE 2406, in response to variations in the measurement results. The measurement procedure and/or the network functionality for reconfiguring the OTT connection may be implemented in software and hardware of the host 2402 and/or UE 2406. In some embodiments, sensors (not shown) may be deployed in or in association with other devices through which the OTT connection 2450 passes; the sensors may participate in the measurement procedure by supplying values of the monitored quantities exemplified above, or supplying values of other physical quantities from which software may compute or estimate the monitored quantities. The reconfiguring of the OTT connection 2450 may include message format, retransmission settings, preferred routing etc.; the reconfiguring need not directly alter the operation of the network node 2404. Such procedures and functionalities may be known and practiced in the art. In certain embodiments, measurements may involve proprietary UE signaling that facilitates measurements of throughput, propagation times, latency and the like, by the host 2402. The measurements may be implemented in that software causes messages to be transmitted, in particular empty or ‘dummy’ messages, using the OTT connection 2450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a first network node in a communications network including a second network node, one of the first network node and the second network node being a master node, MN, and the other of the one of the first network node and the second network node being a secondary node, SN, the method comprising:
communicating (1810) measurement gap configuration information with the second network node, the measurement gap configuration information comprises at least one of: an indication of a set of candidate measurement gap configurations; and an indication of a selected candidate measurement gap configuration of the set of candidate measurement gap configurations selected by the SN; and
responsive to communicating the measurement gap configuration information, communicating (1840) with a communication device using a measurement gap configuration based on the measurement gap configuration information.

2. The method of claim 1, wherein the first network node is the MN, and
wherein the second network node is the SN.

3. The method of claim 2, wherein communicating the measurement gap configuration information comprises:
transmitting an indication of a set of candidate measurement gap configurations to the second network node; and
receiving an indication of a selected candidate measurement gap configuration of the set of candidate measurement gap configurations from the second network node.

4. The method of claim 1, wherein the first network node is the SN, and wherein the second network node is the MN.

5. The method of claim 4, wherein communicating the measurement gap configuration information comprises:
receiving an indication of a set of candidate measurement gap configurations from the second network node; and
transmitting an indication of a selected candidate measurement gap configuration of the set of candidate measurement gap configurations to the second network node.

6. The method of claim 1, wherein communicating the measurement gap configuration information comprises communicating the measurement gap configuration information as part of a SN Addition procedure or a SgNB Modification procedure.

7. The method of claim 1, wherein the measurement gap configuration information comprises at least one of:
an indication of whether the measurement gap configuration is to be perFR1, perFR2, a mix of perFR1 and perFR2, or perUE;
an indication of a condition during which to apply the measurement gap configuration;
an indication of a measurement gap pattern; and
an indication of whether the measurement gap configuration is mandatory or optional for the MN.

8. The method of claim 1, further comprising:
determining (1820) the measurement gap configuration based on the measurement gap configuration information.

9. The method of claim 8, wherein the first network node comprises a centralized unit, CU, and a distributed unit, DU,
wherein communicating the measurement gap configuration information comprises receiving, by the CU, the measurement gap configuration information from the second node, and
wherein determining the measurement gap configuration comprises determining, by the DU, the measurement gap configuration based on the measurement gap configuration information received from the CU.

10. The method of claim 1, further comprising:
transmitting (1830) confirmation of the measurement gap configuration associated with the communication device with the second network node.

11. The method of claim 1, wherein communicating the measurement gap configuration information comprises communicating the measurement gap configuration information in response to the MN initiating a SN Addition procedure or a Dual Connectivity Setup procedure.

12. The method of claim 1, wherein communicating the measurement gap configuration information comprises communicating the measurement gap configuration information prior to the MN performing a radio resource control, RRC, reconfiguration with the communication device.

13. A first network node (1600) in a communications network including a second network node, one of the first network node and the second network node being a master node, MN, and the other of the one of the first network node and the second network node being a secondary node, SN, the network node comprising:
processing circuitry (603) configured to perform any of the operations of claim 1; and
power supply circuitry configured to supply power to the processing circuitry.

14. A first network node (1600) in a communications network including a second network node, one of the first network node and the second network node being a master node, MN, and the other of the one of the first network node and the second network node being a secondary node, SN, the network node comprising:
processing circuitry (1603); and
memory (1605) coupled to the processing circuitry and having instructions stored therein that are executable by the processing circuitry to cause the network node to perform operations comprising any of the operations of claim 1.

15. A computer program comprising program code to be executed by processing circuitry (1603) of a first network node (1600) in a communications network including a second network node, one of the first network node and the second network node being a master node, MN, and the other of the one of the first network node and the second network node being a secondary node, SN, whereby execution of the program code causes the network node to perform operations comprising any operations of claim 1.

16. A computer program product comprising a non-transitory storage medium (1605) including program code to be executed by processing circuitry (1603) of a first network node (1600) in a communications network including a second network node, one of the first network node and the second network node being a master node, MN, and the other of the one of the first network node and the second network node being a secondary node, SN, whereby execution of the program code causes the network node to perform operations comprising any operations of claim 1.

17. A non-transitory computer-readable medium having instructions stored therein that are executable by processing circuitry (1603) of a first network node (1600) to cause the network node to perform operations comprising any of the operations of claim 1.
